(19) United States
(12) Patent Application Publication
(10) Pub. No.: US 2010/0064046 A1
(43) Pub. Date: Mar. 11, 2010

(54) MANAGEMENT OF COMMUNICATIONS FROM STOLEN DEVICES

(75) Inventors: Byron Jung, Burnaby (CA); Tracinda Plenert, Aldergrove (CA); Lyle Singular, Surrey (CA); Tedric Mah, Burnaby (CA)

Correspondence Address: KNOBBE MARTENS OLSON & BEAR LLP, 2040 MAIN STREET, FOURTEENTH FLOOR, IRVINE, CA, 92614, US

(73) Assignee: ABSOLUTE SOFTWARE CORPORATION, Vancouver (CA)

(21) Appl. No.: 12/557,385

(22) Filed: Sep. 10, 2009

Related U.S. Application Data
(60) Provisional application No. 61/095,889, filed on Sep. 10, 2008.

(51) Int. Cl. G06F 17/30; G06F 15/16

(52) U.S. Cl. 709/227; 707/758; 707/E17.014

(57) ABSTRACT

A device, method, system and computer readable medium are disclosed for the management of communications provided by a multitude of stolen electronic devices reporting location information to a monitoring center.

### CROSS-REFERENCE TO RELATED APPLICATION

This application claims the benefit of U.S. Provisional Patent Application No. 61/095,889, filed Sep. 10, 2008, priority from the filing date of which is claimed under 35 U.S.C. §119, and which is hereby fully incorporated by reference.

### BACKGROUND

The present disclosure relates to computer-assisted methods and systems for using device-reported data to assist in the recovery of stolen electronic devices.

Laptops, and increasingly other electronic devices such as cell phones, PDAs, smart phones (e.g. BlackBerry™, iPhone™), memory sticks, personal media devices (e.g. iPod™), gaming devices and personal computers, are being remotely tracked so that they can be recovered in the event of theft. Such tracking may be effected by sending location information to a remote storage site or an email server.

Proprietary information is routinely stored on electronic devices such as personal computers, laptop computers and personal digital assistants, and the need to protect such proprietary or sensitive data, and to recover such devices if they are lost or stolen, is self-evident. There is also a need to recover such property as efficiently as possible without placing an undue burden on law enforcement agencies.

Accordingly, various systems and methods addressing the need to recover stolen electronic devices have been proposed.

By way of example, U.S. Pat. No. 6,958,688 discloses a system and method for conveniently notifying law enforcement authorities, security agencies or a website upon the theft of property. The authorities to whom notification is made are those closest to the owner reporting the loss. Over time, authorities further afield are automatically notified if the property is not recovered.

U.S. Pat. No. 5,715,174 describes a method and apparatus for enabling a stolen electronic device to transmit details of its location to a monitoring server, which can then notify authorities in the vicinity of the missing equipment.

However, notifying authorities of a theft is only the first step to recovering stolen property, and in many cases, the property is not retrieved if this is the only step taken. A stolen device may often be taken to or sold to someone in another locality. Notifying authorities in such other locality that there is a stolen device at a particular whereabouts in their jurisdiction may not be enough for them to act, especially if it is the first notification of it that they receive. Authorities may first need to receive a theft report from the owner of the property, they may not accept automated or email notifications, or they may need more information than a location to act, such as a possible name or image of a thief, or they may require evidence that the device has been at a particular location for a certain period of time. As stolen goods may be moved from one locality to another, or due to the portability of such a device in the hands of an unwitting purchaser, the notification of all police departments en route may create an unnecessary burden.

There is therefore a further need to ensure that adequate information is optimally collated and supplied in a tailored and timely fashion to the single, correct authority. Such a need would ideally be fulfilled without placing undue burden on police authorities.

### SUMMARY

This summary is not an extensive overview intended to delineate the scope of the subject matter that is described and claimed herein. The summary presents aspects of the subject matter in a simplified form to provide a basic understanding thereof, as a prelude to the detailed description that is presented below.

In practice, the victim of a theft is obliged to report the theft to the police department operating in the locality where the crime occurred. This is the correct department to which all information pertaining to the theft should be sent. If a stolen device ends up in another locality, it is the responsibility of the police department receiving the theft report to officially transfer the theft file to police in the other locality.

Where the theft is of an electronic device that reports its location to a monitoring center, the monitoring center may have a facility to allow owners and legitimate users of stolen devices to provide details of a theft (such as via a website), including details of the stolen device and the police department to which the theft was reported. On receipt of such a report from an owner or user, a “stolen” flag is set in the monitoring center database in relation to the device. When the stolen device later calls in to the monitoring center, the agent within the device communicates with the monitoring center server and provides its ID, which allows the monitoring center to retrieve from its database the locality and details of the police department to which the theft report was made. This locality may be different from the current locality of the device, the owner's residence and the owner's place of work.

The information provided by the stolen device relating to its own current location can then be channeled to the correct police department, either directly, or via an investigator who first compiles additional information regarding the theft. This additional information can include, for example, information relating to the stolen device's location over a period of time, images taken by the device, keystrokes used by the thief and websites visited by the thief. The information can be tailored to suit the requirements and preferences of the police department to which the theft was initially reported.

### DESCRIPTION OF THE DRAWINGS

For a fuller understanding of the nature and advantages of the disclosed subject matter, as well as the preferred mode of use thereof, reference should be made to the following detailed description, read in conjunction with the accompanying drawings. In the drawings, like reference numerals designate like or similar steps or parts.

FIG. 1 is a schematic functional block diagram of a system and method for the management of calls from stolen electronic devices in accordance with an embodiment of the disclosed subject matter.

FIG. 2 is a functional flow diagram schematically showing the interactions of a stolen device and a monitoring center and their interplay with users with the system in accordance with embodiments of the disclosed subject matter.

FIG. 3 is a functional flow diagram schematically representing closer detail of an aspect of the functionality of embodiments of the disclosed subject matter.

FIG. 4 is a functional flow diagram schematically representing a variation of an embodiment of the disclosed subject matter.

FIG. 5 is a functional flow diagram schematically representing a variation of an embodiment of the disclosed subject matter.

### DETAILED DESCRIPTION OF SPECIFIC EMBODIMENTS

### A. Terminology

Device—The term “device” refers herein to an electronic device that may be stolen. The device may be any electronic device, such as a laptop computer, a personal computer, a netbook, a cellphone, a smartphone, a Blackberry™, an iPhone™, an iPod™, a personal gaming device or a memory module. The device can also be referred to as a “client”, and more specifically as a client of a monitoring center. The device typically has an identification number (ID), or electronic serial number (ESN) with which it can be identified. The device can be considered a “host” to the agent.

Agent—as used herein, is a software, hardware or firmware agent that is ideally persistent and stealthy, and that resides in a computer or other electronic device. The agent provides servicing functions which require communication with a remote server. The agent is ideally tamper resistant and/or can self-repair, and may be enabled for supporting and/or providing various services such as data delete, firewall protection, data encryption, location tracking, message notification, and software deployment and updates. An illustrative embodiment of an agent is found in the commercially available product Computrace Agent™. The technology underlying the Computrace Agent™ has been disclosed and patented in the U.S. and other countries, which patents have been commonly assigned to Absolute Software Corporation. See, for example, U.S. Pat. Nos. 5,715,174; 5,764,892; 5,802,280; 6,244,758; 6,269,392; 6,300,863; and 6,507,914 and related foreign patents. Details of the persistent function of an agent are disclosed in U.S. Patent Application Publication Nos. US2005/0216757 and US2006/0272020. The technical disclosures of these documents are fully incorporated by reference as if fully set forth herein. It is feasible to use an equivalent agent to the Computrace Agent™, or less preferably an alternative agent with less functionality. For the purposes of the present disclosure, the minimal functional attributes of the agent are to facilitate communications between the electronic device and a monitoring center and provide or enable provision of location information to the monitoring center. Communications may be initiated by the agent, by the monitoring center or by both.

Monitoring Center—This is a guardian server or other computer or server that the agent communicates with or sends a message to. It may be an email server or it may be a distribution of servers or other computers. For example, provided an internet connection is available to the host, an agent may call the monitoring center at some random or selected suitable interval to report the location of the host, download software upgrades if there are any and repair any security modules that are or should be installed on the host. In the embodiments disclosed herein, the agent would upload location information to a remote storage facility located in the monitoring center. Communication to the monitoring center may take place, for example, via a wired or wireless telephone network, WIFI, WIMAX, cable or satellite. The monitoring center is the main center of the functionality of the system described herein.

Locality—this term is used to describe an extended area, such as a district, town or city, in which there is typically one police department. Localities generally do not overlap each other.

Location—this term is used to describe a more specific place within a locality. For example, it could refer to a street address, an IP address or a set of GPS coordinates.

The detailed descriptions within are presented largely in terms of methods or processes, symbolic representations of operations, functionalities and features of the invention. These method descriptions and representations are the means used by those skilled in the art to most effectively convey the substance of their work to others skilled in the art. A software implemented method or process is here, and generally, conceived to be a self-consistent sequence of steps leading to a desired result. These steps involve physical manipulations of physical quantities. Often, but not necessarily, these quantities take the form of electrical or magnetic signals capable of being stored, transferred, combined, compared, and otherwise manipulated. It will be further appreciated that the line between hardware, software and firmware is not always sharp, it being understood by those skilled in the art that software implemented processes may be embodied in hardware, firmware, or software, in the form of coded instructions such as in microcode and/or in stored programming instructions. In general, unless otherwise indicated, singular elements may be in the plural and vice versa with no loss of generality. The use of the masculine can refer to masculine, feminine or both.

### B. Exemplary Embodiment

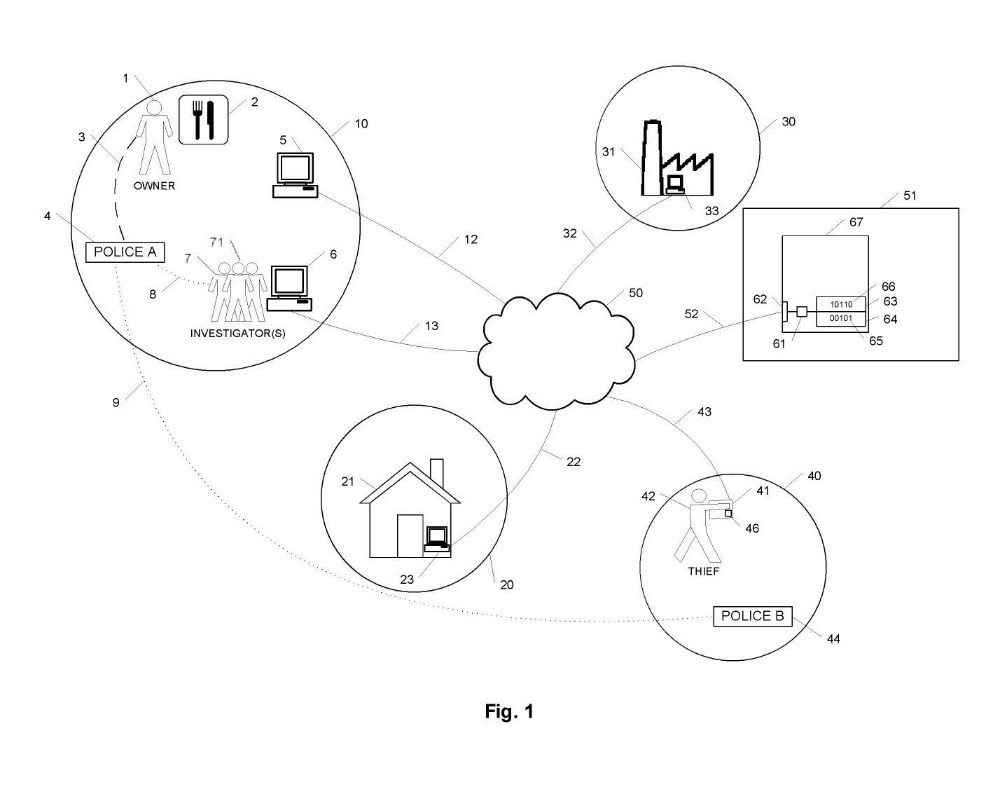

A schematic functional block diagram of a preferred embodiment of the stolen device call management system is shown by way of example in FIG. 1. The system generally comprises a monitoring center 51 connected via data communication link 52 and the internet 50 to remote terminals 5, 6 in a locality 10. Other remote terminals 23, 33 in other localities 20, 30 may be connected via data communication links 22, 32 and the internet 50 to the monitoring center 51.

The monitoring center 51 comprises a server 67, in turn comprising components usually found in a server, such as a processor 61 and electronic memory 63, 64, the electronic memory 63 carrying computer readable instructions 66 that can be acted upon by the processor 61 in order to fulfill functions of the system, and the electronic memory 64 carrying computer readable data 65 that must be stored and processed in order for the system to operate as described. Also included is an interface 62 between the server 67 and the internet 50.

### C. Exemplary Scenario

A typical scenario in which the system may be used can also be seen in FIG. 1, and is described in relation to a stolen laptop 41. However, it is equally valid with an electronic device other than a laptop.

An owner 1 is initially in a locality 10, for example visiting a restaurant 2 on a business trip. He becomes aware that his laptop 41 is missing and informs 3 the police A 4 having authority in the same locality 10 as where the theft occurred. The owner then finds an internet access point or remote terminal 5 connectable via data communications link 12, the internet 50 and data communications link 52 to the system's server 67. At remote terminal 5, the owner 1 provides information to the server 67 pertaining to the fact that his laptop 41 has been stolen and may provide details of the police report filed. Alternately, the owner 1 may provide such information to the server 67 at a later time, and/or in a different locality. For example, the owner can provide details of the theft from a remote terminal 33 at work 31, in locality 30, or he may provide details via remote terminal 23 at his home 21 in locality 20.

Meanwhile, the stolen laptop 41 could be anywhere, and has been depicted in this scenario to be in the hands of a thief 42 in locality 40. The agent 46 in stolen laptop 41 is configured to communicate with the server 67 in the monitoring center 51 via communication link 43, the internet 50 and communication link 52. The agent 46 in the laptop 41 may initiate the communication at a set time or after a set delay, or it may be configured to accept a communication call from the server 67 in the monitoring center 51.

When the laptop 41 communicates with the monitoring center 51, the monitoring center 51 is supplied (by agent 46 in laptop 41) with information as to the location and ID of the laptop 41. With this information, the system retrieves the details of the theft of the laptop 41 and determines the locality 10 that the theft was reported in. The server 67 sends details of the laptop's ID and location, via link 52, internet 50, and link 13 to remote terminal 6 operated by one of a team of investigators 7 operating in the locality 10 in which the theft occurred. The details may initially be sent to a manager 71 of the team who distributes the task of investigating to one of the team members 7. Depending on the size of the locality 10 and the number of thefts, only a single investigator 7 or manager 71 may be needed instead of a team.

The investigator 7, working in the same locality 10 as the Police Department A 4 to which the theft was reported, has detailed knowledge of the requirements and preferences of that police department 4, and the level and amount of information needed to be provided and to whom, in order to optimally assist the police 4 to recover the stolen laptop 41. Further, the investigator's 7 working hours can be aligned with those of the police department 4 by working in the same locality 10. The investigator may use remote access tools to gather information from the stolen laptop 41. This information may contain an indication of the identity of the thief 42 or further clarification of his address. It may also include images taken by the laptop's in-built webcam, if present, which may be images of the thief 42 or the location of the laptop. When enough information has been collected and collated, the investigator 7 uses his established working relationship and communication link(s) 8 with the police 4 to transfer the information to them. Once all the relevant and necessary information has been gathered and transferred to the Police Department A 4, they can transfer the file through official channels 9 to the Police Department B 44 operating in the locality 40 of the stolen device 41.

The system therefore results in the efficient transfer of the optimum amount of information to the police 44, through the appropriate channels 8, 9, in order to help them recover the stolen laptop 41.

### D. Functional Operation

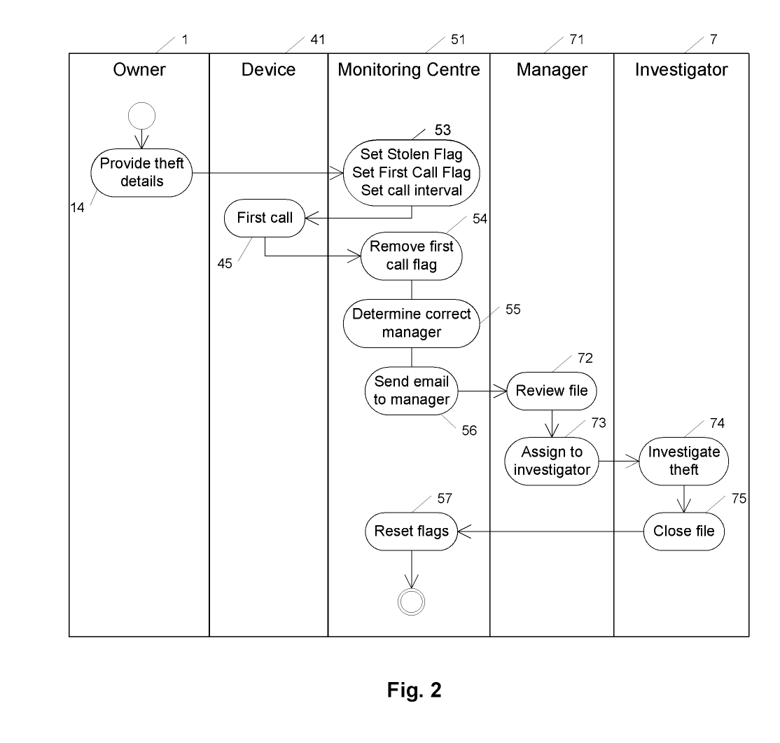

FIG. 2 is a functional flow diagram showing the interactions of the monitoring center 51 and the stolen device 41, and their interplay with the owner of the stolen device and with members of the investigative team working to retrieve the stolen device. In the first instance, an owner 1 becomes aware that his electronic device 41 is missing. The owner 1 of a device into which an agent 46 has been installed and configured to communicate with a monitoring center 51 provides 14 details of the theft to the monitoring center 51, which may be before or after the owner 1 reports the theft to the police 4. If before, further information can be added afterwards. As is described further below, different levels of monitoring service may be selected or purchased either at the time that agent 46 is installed and configured, or subsequently.

Upon receipt of the owner's submission of theft details, the server 67 in the monitoring center 51 sets 53 flags relating to the record of the stolen device 41 in its database. These flags include a flag to indicate that the device 41 is stolen and a flag that the monitoring center 51 is awaiting a first call post-theft from the device 41. It is also possible to set a shortened call interval such that when the stolen device 41 calls in, it is instructed to call into the monitoring center 51 more often than prior to the theft.

When the stolen device 41 is connected to the internet, either via a dial-up, broadband, wireless or other type of connection, the device 41 makes 45 a first post-theft call to the server 67 within the monitoring center 51. As a result of receiving the first call, the server 67 removes 54 the First Call flag and determines 55 the correct investigation team manager 71 to send the details of the theft to. The determination step is further explained below. The details may be sent 56 by automated email to the investigation manager 71, who then reviews 72 the file and assigns 73 it to an appropriate investigator 7. The investigator 7 investigates 74 the theft, possibly using remote access tools for retrieving addition information from the stolen device 41. A human investigator is often needed to interpret the output from the currently available remote access tools and to distil it down to concise and meaningful information. However, it is envisaged that completely automated tools will become available in the future. After the investigator has collected enough information, he closes 75 the file, causing the monitoring center 51 to reset 57 the flags. If for any reason the device does not call in for an extended period of time and the case become a cold file, the flags may also be reset.

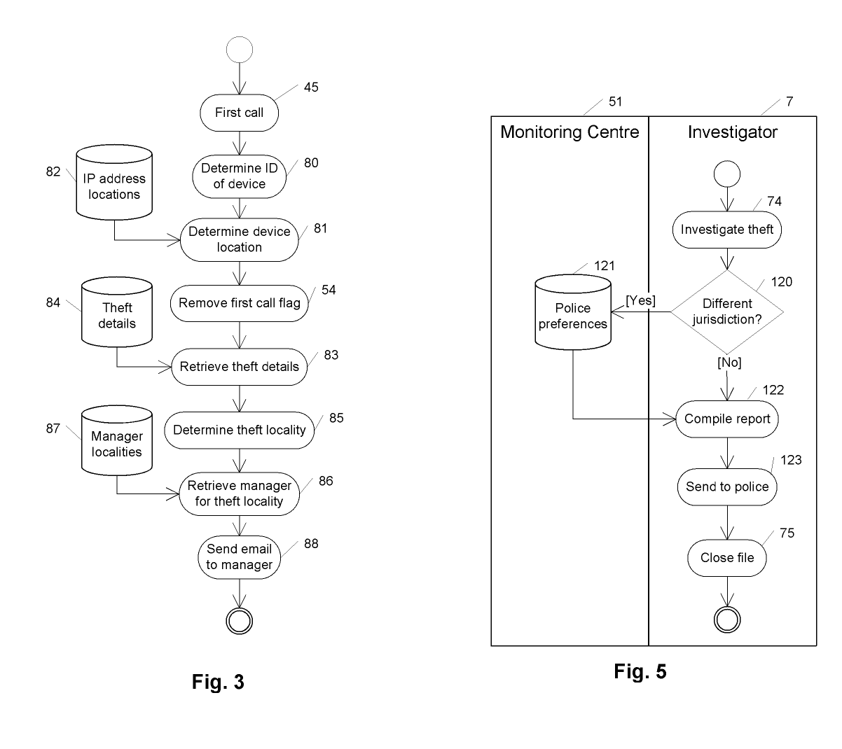

FIG. 3 is a functional flow diagram showing the functioning of the server 67 in more detail, and showing how the correct investigation manager 71 is determined. Following the initiation of the first call 45, the monitoring center 51 determines 80 the ID of the device 41 that is making the call, from information supplied by the agent 46 in the device 41. The monitoring center 51 also determines 81 the location 40 of the device 41 by receiving the device's IP address from or via the assistance of the agent 46. The monitoring center 51 optionally accesses from a database 82 an area in which the IP address is located, which may be within a single locality 40 or span a group of localities. Following a successful first post-theft call, the first call flag is removed 54. The monitoring center 51 retrieves 83 theft details from its database 84 (which is populated with details of monitored devices reported to have been stolen) available details of the device 41 reported stolen. From the theft details, the monitoring center 51 determines 85 the locality 10 the theft was reported in. From the system's database 87 of investigator manager localities, the system retrieves 86 the manager 71 working in the locality 10 that the theft was reported in. The monitoring center 51 then sends the theft details via email 88 to the appropriate manager 71. The theft details may additionally include current IP address and current locality 40 of the device. A manager may operate in more than one locality.

### E. Multiple Device Theft, Multiple Investigators, Shift Work and Service Levels

A variation of the system can include functionality to additionally determine which investigator in a team of investigators to assign the investigation task to. This may be desirable in the case where a team of investigators work in an area comprising multiple localities and multiple corresponding police departments. Within such an area, individual investigators may have established relations with some police departments but not others. There may be some overlap, in that more than one investigator has dealt with the same police department. The team of investigators may be organized to work in shifts in order to provide a 24 hour investigation service.

It often occurs that multiple electronic devices are stolen at the same time, for example, during a break-in at a school, business or library. The thief often sells these on to others so they end up in different localities. For reasons of efficiency, it is important in these cases that the police authority to which the theft was reported receives all the information related to the crime, rather than sending the information out cold and in fragments to multiple police departments in the other localities. In order to facilitate this, the server uses the theft details (device IDs, etc.) reported by the owner to associate each reporting device with a single theft event or record so that the theft details can all be forwarded to the same investigator, who will collate the information then pass it on to the appropriate police department.

It may be the case that different owners have purchased or require different service levels. For example, a premium service level may specify immediate investigative action, in which case the monitoring center 51 and agent 46 should be configured such that the monitoring center 51 can initiate calls to the agent 46, for example by an internet connection or via a cellular or satellite communications network connection. In the latter case, the monitoring center 51 could send an SMS message to the agent 46, which then causes the agent to wake up the stolen device 41 and provide location information. Location information could be provided by GPS receiver built into the device, A-GPS, IP address, WiFi signal strength field, WiMAX or hotspot ID, cell tower triangulation, or other suitable methods. In contrast, a regular service may require starting investigation only after the stolen device 41 calls in, according to the next call time programmed into the agent 46.

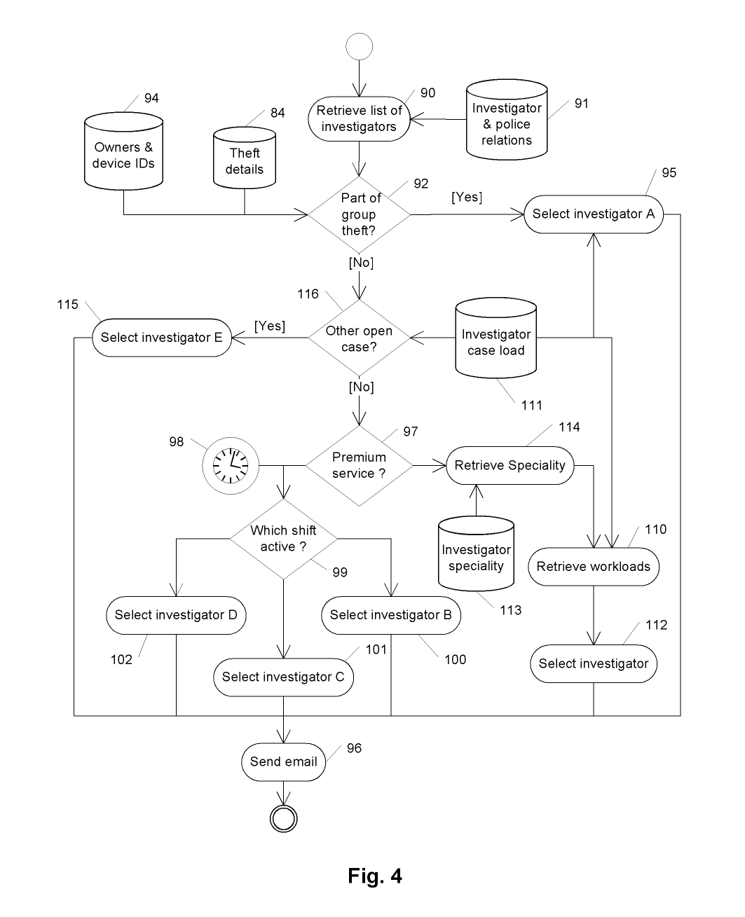

Referring now to FIG. 4, the server 67 of monitoring center 51 retrieves 90, from the system's database 91, the list of available investigators having working relationships with police in the locality of the theft. This can be in addition to or instead of step 86 of FIG. 3. Using information from the database containing theft details 84 and the database containing the device ID's and their corresponding owner's details 94, the monitoring center server 67 automatically determines 92 whether the device 41 belongs to an owner who has other devices for which theft details have already been received by the monitoring center. If so, and if the thefts were all reported in the same locality, then, using stored details 111 relating existing investigation cases to investigators, the system selects 95 the investigator, for example Investigator A, who is working on the recovery of that particular owner's other device(s). If an owner has multiple devices reported stolen in different localities as a result of different theft incidents, it is preferable but not necessary that the same investigator is only chosen if he has working relationships with the police in both localities. Following the selection, an email of the new case is sent 96 to the selected investigator. This may be in addition to sending 88 an email to the investigator's manager, or alternately the email may be sent to only the manager who reviews the file before forwarding the email to the investigator.

If the device that has communicated with the monitoring center is not determined 92 to be part of a group theft, it may be the case that an investigator is already working on another case with the police agency to which the theft was reported. For the purpose of optimizing efficiency, it is to this investigator that it is generally best to assign the investigation of the newly stolen device investigation to. Using knowledge 84 of the police department to which the theft was reported, knowledge 91 of the investigator and police relations and knowledge 111 of investigators' current caseloads, the system checks in step 116 whether there are any other open cases for the police department to which the stolen device was reported. If so, the system selects 115 Investigator E who is already working on the other open case with that police department. As above, an email of the new case is then sent 96 to the selected investigator and/or manager.

If 116 there are no open cases for the police department in question, the monitoring center 51 can determine 97, from details of the owner, the level of service that the owner has purchased. If, for example, the service level is premium, the system determines 99 which shift is active based on the time 98 of the first call, or communication of the theft to the system. For example, Investigator B could be selected 100 if the first call is early morning, Investigator C could be selected 101 if the time of the first call is in the afternoon, and investigator D could be selected 102 if the time of the first call is overnight. If the service level required is not premium, further rules may be implemented to decide which investigator to assign the recovery assistance to.

Since the disclosed subject matter relates to the management of incoming calls from many types of electronic devices, different investigators may be specialized in tracking and collating information from different device types (e.g. laptops calling on wirelines versus mobile devices calling over cellular networks). The system can be configured to assign a case to an investigator based on his expertise with a device type. The system retrieves 114 from a datastore 113 a list of one or more of the available investigators having specialized experience with the type of device stolen.

The system can then retrieve 110 the existing case loads of the available investigators having the appropriate expertise from database 111 for selection 112 of an investigator such that the overall workload of the team of investigators is as balanced as possible. Maximum workloads for each investigator can be set in database 111 according to their level of experience, the number of hours in their working week and their preferences to the amount of overtime they would like to work.

Following selection 112 of an investigator according to one or more of the above rules, an email is sent 96 to the investigator and/or manager.

### F. Police Preferences

FIG. 5 is a functional flow diagram of a further variation. Since it often occurs that a stolen device is located in a police jurisdiction other than where it was stolen, it is useful for the investigators to be knowledgeable of the police requirements in the jurisdiction where the stolen device 41 is located. To facilitate this, the monitoring center 51 can further comprise a database 121 of police preferences. These preferences may include main contact person, direct telephone line, hours of operation, quantity and type of information required, preferred method of communication and other relevant information. During the investigation 74 of a theft, the monitoring center 51 may indicate 120 to the investigator that the location of the stolen device 41 is in a jurisdiction other than that which the theft was reported in. If so, the investigator 7 accesses the database 121 containing police preferences and then compiles 122 the information report taking this into consideration. When complete, the report is sent 123 to the police where the theft was reported and the file is closed 75. A further advantage of this is that there may be no established official communication channel 9 between the Police Department A 4 where the theft was reported and the Police Department B 44 in the locality where the stolen device is located. It is therefore useful to include in the investigator's report the details and preferences of the police department to which the file should be sent. Doing this improves efficiency by eliminating or reducing the need for some preliminary discussions between the police departments in order to set up an official channel, and by providing an established preferred format for the transfer of the investigator's information.

### G. Further Alternatives and Variations

The specified steps can be made in a different order to that shown, and certain steps may be given priority over other steps. Some of the steps may be omitted and others may be included which may depend on other parameters not mentioned herein. Other parameters could include language in the country the theft was reported in, languages spoken by the investigator and language used by the thief. Steps may be repeated or combined, for example, referring to FIG. 4, both the investigator specialty and the service level could be assessed for a given device that calls in.

Communications between the monitoring center and the stolen devices may be via a telecommunications network, such as a cellular or satellite telephone network. This may be as well as, or instead of communicating via the internet.

Although the investigators have been shown to be physically present in the localities in which a theft is reported, this is not a necessity. In particular, an investigator may have strong working relationships with police departments in several localities, but can only be located in one of them. In another variation, an investigator may be located remotely from all of the police departments with which he has a good working relationship. This is because the working relationships of an investigator with police in particular localities are of greater relevance to the operation of the disclosed subject matter than the actual physical location of an investigator.

The disclosed subject matter has been presented as interacting with investigators who are outside the police, preferably employees of a security company. However, the investigators may also or in the alternative be police officers.

The databases shown in the figures have been shown as separate databases for clarity. In practice, some or all of these may be combined in a single database.

The present description is of the best presently contemplated mode of carrying out the subject matter disclosed and claimed herein. The description is made for the purpose of illustrating the general principles of the subject matter and not be taken in a limiting sense. The subject matter can find utility in a variety of implementations without departing from the scope of the disclosure made, as will be apparent to those of skill in the art from an understanding of the principles that underlie the subject matter.

Except where indicated otherwise, all of the steps and tasks described herein may be performed and fully automated by a machine, and may be embodied in software code modules executed by one or more general purpose computers. The code modules may be stored in any type of computer-readable medium or other computer storage device. Some or all of the methods may alternatively be embodied in specialized computer hardware. The machine may, in some cases, be composed by multiple distinct computers or computing devices (e.g., physical servers, workstations, storage arrays, etc,) that communicate and interoperate over a network to perform the described functions. Each such computing device typically includes a processor (or multiple processors) that executes program instructions stored in a memory. The results of the disclosed methods may be persistently stored by transforming physical storage devices, such as solid state memory chips and/or magnetic disks, into a different state.

We claim:

1. A computer-implemented method, comprising:
a. maintaining a computer data repository of data regarding reported electronic device theft events, said data repository including information regarding geographic locations of said reported theft events, and including identifiers of the devices associated with said theft events;
b. receiving information over a network from a device, said information including at least an identifier of the device and information regarding the location of the device;
c. accessing the computer data repository to determine, based on the received identifier of the device, whether the device is associated with a reported theft event; and
d. when the device is determined to be associated with a reported theft event, automatically selecting, based on at least the information regarding the location of the reported theft event, a particular investigative entity to which to send at least said information regarding the location of the device, said step of automatically selecting performed by a machine.

2. The method of claim 1, wherein said computer data repository further includes information regarding the geographic boundaries of police department localities, and wherein the automatic selection of a particular investigative entity to which to send at least said information regarding the location of the device is further based on the locality within which lies the geographic location of the reported theft event.

3. The method of claim 1, further comprising, in response to determining that the device is associated with a reported theft event, sending at least said information regarding the location of the device to said investigative entity.

4. The method of claim 1, further comprising, in response to determining that the device is associated with a reported theft event, automatically initiating a communication to the device to cause the device to modify the frequency with which it reports at least its location.

5. A computer server comprising an interface for connection to a communications network, a processor, and a memory, said computer server being connected to a communications network and configured to:
a. maintain a computer data repository of data regarding reported electronic device theft events, said data repository including information regarding geographic locations of said reported theft events, and including identifiers of the devices associated with said theft events;
b. receive information over a network from a device, said information including at least an identifier of the device and information regarding the location of the device;
c. access the computer data repository to determine, based on the received identifier of the device, whether the device is associated with a reported theft event; and,
d. when the device is determined to be associated with a reported theft event, automatically select, based on at least the information regarding the location of the reported theft event, a particular investigative entity to which to send at least said information regarding the location of the device, said step of automatically selecting performed by a machine.

6. The computer server of claim 5, wherein said computer data repository further includes information regarding the geographic boundaries of police department localities, and wherein the automatic selection of a particular investigative entity to which to send at least said information regarding the location of the device is further based on the locality within which lies the geographic location of the reported theft event.

7. The computer server of claim 5 further configured to send at least said information regarding the location of the device to said investigative entity upon determining that the device is associated with a reported theft event.

8. The computer server of claim 5 further configured to automatically initiate a communication to the device to cause the device to modify the frequency with which it reports at least its location upon determining that the device is associated with a reported theft event.

9. A system for managing communications with stolen electronic devices comprising:
a. a computer data repository for maintaining data regarding reported electronic device theft events, said data repository including information regarding geographic locations of said reported theft events, and including identifiers of the devices associated with said theft events;
b. a network for receiving information from a device, said information including at least an identifier of the device and information regarding the location of the device; and,
c. a computer server connected to said network and configured to access the computer data repository to determine, based on the received identifier of the device, whether the device is associated with a reported theft event and, when the device is determined to be associated with a reported theft event, automatically select, based on at least the information regarding the location of the reported theft event, a particular investigative entity to which to send at least said information regarding the location of the device, said step of automatically selecting performed by a machine.

10. A computer readable medium which stores program code that instructs a user computing device to perform a method that comprises:
a. maintaining a computer data repository of data regarding reported electronic device theft events, said data repository including information regarding geographic locations of said reported theft events, and including identifiers of the devices associated with said theft events;
b. receiving information over a network from a device, said information including at least an identifier of the device and information regarding the location of the device;
c. accessing the computer data repository to determine, based on the received identifier of the device, whether the device is associated with a reported theft event; and,
d. when the device is determined to be associated with a reported theft event, automatically selecting, based on at least the information regarding the location of the reported theft event, a particular investigative entity to which to send at least said information regarding the location of the device, said step of automatically selecting performed by a machine.
